(19) United States
(12) Patent Application Publication
(10) Pub. No.: US 2026/0249372 A1
(43) Pub. Date: Aug. 27, 2026

(54) METHOD FOR POLISH GRINDING OF GEARS WITH A POLISH GRINDING TOOL IN A GEAR GRINDING MACHINE

(71) Applicant: KAPP NILES GmbH & Co. KG, Coburg (DE)

(72) Inventors: Nico SCHILLING, Lautertal (DE); Lars LUTHER, Meeder (DE)

(21) Appl. No.: 19/455,288

(22) Filed: Jan. 21, 2026

(30) Foreign Application Priority Data
Feb. 26, 2025 (DE) 10 2025 107 235.3

(51) Int. Cl. B23F 23/12; B23F 5/04

(52) U.S. Cl. CPC B23F 23/1218; B23F 5/04; B23F 23/1225

(57) ABSTRACT

A method for polish grinding gears with a polish grinding tool in a gear grinding machine. The method includes the following steps: a) Measuring tooth flanks of a tooth gap on a pre-ground reference gear over the tooth height and tooth width at a number of measuring points, polish grinding the gear with a first initial radial infeed, re-measuring the flank surface, comparing the measured position of the tooth flanks with the original position; if the comparison shows that not all measuring points have been changed: storing the measured points of the flanks where a change has already occurred and the radial infeed required for this, and repeating the polish grinding with an incrementally increased infeed; b) Determination of a correction value or function for the subsequent polish grinding from the determined radial infeeds that were required for a change at all measured points of the flanks; c) Polish grinding the gears based on the determined correction value or the determined correction function.

### CROSS-REFERENCE TO RELATED APPLICATIONS

The present application claims priority of DE 10 2025 107 235.3, filed Feb. 26, 2025, the priority of this application is hereby claimed, and this application is incorporated herein by reference.

### BACKGROUND OF THE INVENTION

The invention relates to a method for polish grinding of gears with a polish grinding tool in a gear grinding machine.

In the hard finishing of the toothing of a gear, polish grinding is sometimes used as the final step. In this process, only a relatively small amount of material is removed from the surface of the tooth flanks, however the final shape and surface texture (roughness) of the tooth flanks are also defined.

The polish grinding tool used for this purpose usually has abrasive grains that are held in place on a tool base body with a relatively soft bond (consisting of polyurethane, for example). With the appropriate infeed of the tool relative to the workpiece, a polishing effect can indeed be achieved. However, in contrast to the preceding grinding process, it is no longer possible to easily produce the desired geometry of the tooth flanks in a targeted manner.

Nevertheless, it would be advantageous to carry out the final polish grinding process in such a way that the final surface topography of the tooth flanks is also optimal in terms of their geometric position and surface roughness.

### SUMMARY OF THE INVENTION

The invention is based on the object of further developing a process of the type mentioned above in such a way that, even during a polish grinding process, not only is the surface quality (roughness) of the tooth flanks maintained within an optimum range, but also the best possible geometry of the machined gear can be achieved.

The solution to this object provided by the invention is characterized in that the method for polish grinding the gear comprises the steps of:
a) Performing the following steps on a reference gear or test gear:
a1) Measuring at least one tooth gap of the finish ground, but not yet polish ground gear, wherein the position of the surface of the flanks is measured at a number of points on the flanks (measuring points) on both opposing flanks of the tooth gap, both above the tooth height (i.e., over the diameter of the gear) and above the tooth width (i.e., along the width extension of the gear);
a2) Polish grinding the gear with the polish grinding tool, wherein the polish grinding tool is fed to the gear with a first initial radial infeed; a
3) Measuring the surface of the flanks to determine the position of the surface at the number of points on the flanks;
a4) Comparing the measured position of the surface at the number of points on the flanks according to step a3) with the measured position of the surface at the number of points on the flanks according to step a1);
a5′) If the comparison according to step a4) shows that the position of the surface at the number of points on the flanks according to step a3) has changed relative to the measured position of the surface at the number of points on the flanks according to step a1) at all measured points on the flanks: Continue with step b);
a5″) If the comparison according to step a4) shows that the position of the surface at the number of points on the flanks according to step a3) has not yet changed with respect to the measured position of the surface at the number of points on the flanks according to step a1) at least at one of the measured points on the flanks:
   Storing of the measured points on the flanks where a change has already occurred, as well as the necessary radial infeed for that,
   Repeating steps a2), a3), and a4), wherein with each repetition the polish grinding tool is fed to the gear wheel with a radial infeed increased by one increment, wherein continuation with step b) takes place if, after a repetition, a change has occurred at all measured points on the flanks;
b) Determination of at least one correction value and/or at least one correction function for the subsequent polish grinding from the determined radial infeeds that were required for a change at all measured points on the flanks;
c) Polish grinding of gears based on the determined correction value and/or the determined correction function.

The measurement according to step a1) above is preferably performed at exactly one reference tooth gap.

Between 3 and 20 measuring points are preferably arranged equidistantly across the tooth height, and between 3 and 10 measuring points across the tooth width. The lower limit of 5 measuring points is particularly preferred. The selected number of measuring points is usually a compromise between the information content obtained or to be obtained and the time required to perform the measurement. A lower resolution is preferred above the tooth width than above the tooth height (profile) (i.e., a small number of measuring points).

According to a first preferred embodiment of the method, the determination of the aforementioned correction value in accordance with step b) above relates to the symmetry between the two tooth flanks of the tooth gap of the toothing to be polish grinded. In this case, it can be specifically provided that, from the stored radial infeeds at the measured points of the flanks in accordance with step a5″) above, at which a change has occurred for the first time, an average value is formed for both the right flank and the left flank, wherein a compensating rotation angle is determined from the difference between the average values of the left and right flanks, by which the gear wheel is rotated by a machine axis during machining in order to symmetrically polish grinding the opposite flanks of the tooth gap. In this way, the polish grinding process is carried out in such a way that optimally symmetrical flanks are obtained.

A second preferred embodiment provides that the determination of the aforementioned correction function according to step b) above relates to the flank line of the toothing to be polish grinded. In this case, it can be specifically provided that, from the stored radial infeeds at the measured points on the flanks according to step a5″) above, at which a change has occurred for the first time, an average course of the flank line over the width of the toothing is determined, wherein the course of the flank line thus determined is taken into account as a correction during polish grinding in order to obtain a desired course of the flank line.

A third preferred embodiment provides that the determination of the aforementioned correction function according to step b) above relates to the flank profile of the toothing to be polish grinded. In this case, it can be specifically provided that, from the stored radial infeeds at the measured points on the flanks according to step a5″) above, at which a change has occurred for the first time, an average profile of the flank over the height of the toothing is determined, wherein the profile of the flank thus determined is taken into account as a correction when dressing the polish grinding tool in order to obtain a desired profile of the flank during polish grinding.

The three approaches mentioned above can also be used in any combination.

The measurement according to step a1) and step a3) above is preferably carried out with the workpiece clamped in the gear grinding machine.

The measurement according to step a1) above and according to step a3) above is preferably carried out using a tactile measuring element (i.e., in particular, with a measuring probe).

The polish grinding tool is preferably a grinding worm. In this case, the grinding worm preferably has abrasive grains that are held in place by an elastic bond, in particular a plastic bond, and especially preferably a polyurethane bond.

The above-mentioned increment for the radial infeed is preferably between 20 μm and 50 μm, particularly preferably 30 μm.

The proposed procedure thus allows the polish grinding tool to gradually approach the flank surface radially on the basis of the aforementioned increment until the described measurement and comparison with the original surface position of the tooth flanks determines that material has been removed across the entire tooth flanks (step a above). The correction value or correction function (step b above) is then determined on the basis of the preferably single tooth gap considered (i.e., measured) in such a way that the symmetry between the two tooth flanks and/or the flank line and/or the flank profile is optimized during the subsequent polish grinding (step c above).

This improves the quality of the toothing.

In an advantageous manner, a targeted, extensive change in the generative grinding topology can thus be made during polish grinding based on the determined distribution of the penetration depth in accordance with step a) above during the polishing process. This takes place with sufficient accuracy to achieve improved toothing quality.

The process can be automated in the machine; it is operator-independent.

As explained above, the described method follows the finishing of the gear teeth, which already have the desired final contour, i.e., the final geometry, before the described method is carried out. The proposed process merely adjusts the roughness of the tooth flank surface by polishing after finishing.

Roughing and finishing are terms that are commonly used in the present field of technology of gear grinding, so that they do not need to be explained in detail here. Reference is made, for example, to DE 10 2009 043 678 A1 of the applicant.

The method thus enables the distribution of the polishing pressure across the surface of the tooth flanks to be determined in a targeted manner (which is determined iteratively by a sequence of individual steps in accordance with step a above) and converted into correction values or correction functions, which can then be used for polish grinding.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

FIG. 1 shows a general representation of an Abbott curve,

FIG. 2a shows a specific Abbott curve for a tooth flank that has initially only been ground (under-polished curve), whereby an infeed of 5 μm was selected for the grinding and polishing tool,

FIG. 2b shows the Abbott curve of a subsequently polished tooth flank (minimally over-polished), wherein an infeed rate of 30 μm was selected for the polish grinding tool,

FIG. 2c shows the Abbott curve of an even more intensive polished tooth flank (over-polished), wherein an infeed of 90 μm was selected for the polish grinding tool,

FIG. 3 shows measured curves for different resulting roughnesses of the tooth flank over the radial infeed (z) of the polish grinding tool,

FIG. 4a shows measured values recorded during the measurement of the left flank of a reference tooth gap after performing a polish grinding process with a specified radial infeed of the polish grinding tool, wherein the position of the surface of the tooth flank above the tooth height (diameter d of the gear) and the tooth width (b) is shown,

FIG. 4b shows the corresponding recorded measured values for the right flank of the reference tooth gap in the representation according to FIG. 4a,

FIG. 5 shows schematically how a radial infeed of the tool to the gear results in a target penetration (ZD) that is desired for polish grinding,

FIG. 6 shows schematically the target penetration ZD (in μm) over the tooth width (b) for different tooth heights (diameter values from 100 to 106 mm) and

FIG. 7 shows schematically the target penetration ZD (in μm) above the tooth height (d) at different points across the tooth width.

### DETAILED DESCRIPTION OF THE INVENTION

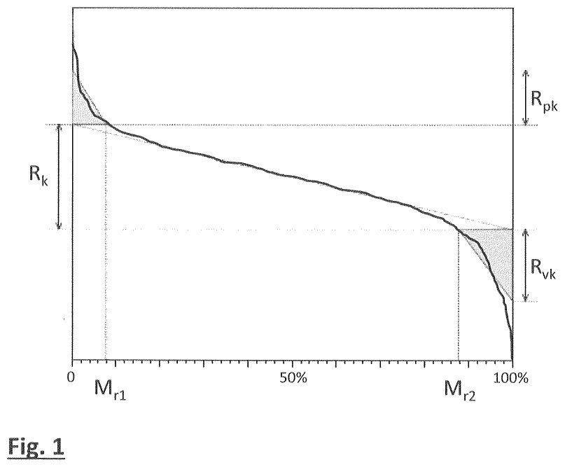

FIG. 1 first shows a general Abbott curve, which can be used to describe the surface texture of a tooth flank. The curve describes the distribution of the height profile of the flank surface and is calculated by integrating (from 0 % to 100 %) the surface profile. The curve is suitable for describing the flank surface and is linked to the parameters Rpk, Rk, and Rvk of the surface roughness.

As can be seen in FIG. 1, for a percentage range (from 0 % to Mr1 at approx. 8 %), the surface roughness is above a central range (Rk) and has a maximum exceeding value of Rpk. For another percentage (from Mr2 at approx. 88 % to 100 %), however, the surface roughness is below the middle range (Rk) and has a minimum value of Rvk.

The ideal tooth flank surface is characterized by minimal deformation due to wear of the roughness peaks. In this case, a high proportion of the surface is available for bearing; at the same time, there is good retention capacity for the lubricant used in the operation of the toothing. This is retained in the roughness valleys. This results beneficially in a toothing that maintains constant meshing conditions and center distances during operation, can transmit high loads, and provides sufficient lubricant for favorable friction conditions. Likewise, a smoother roughness profile leads to lower local power loss due to sliding friction losses in operating conditions with solid-body friction or mixed friction.

At a toothing, the aim is often to achieve a technical surface that is an intermediate stage between an only ground surface and a fully polished surface. The peaks and the roughness profile respectively have already been converted into a polished surface by the polishing process. However, the roughness valleys from the grinding process are retained.

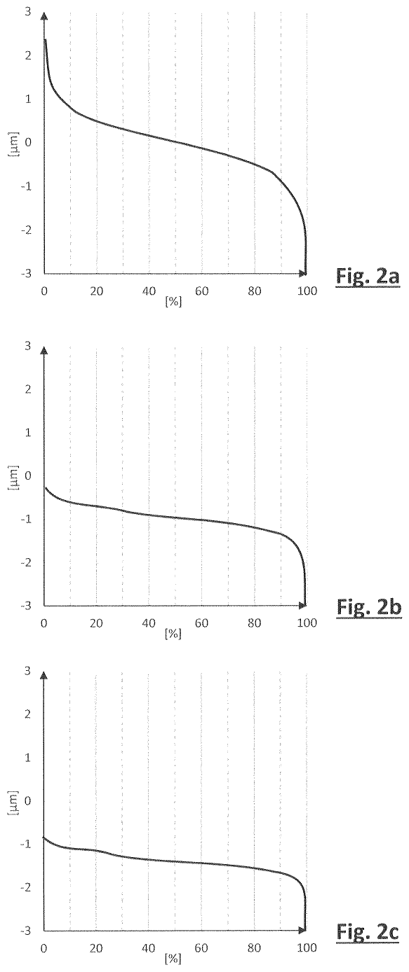

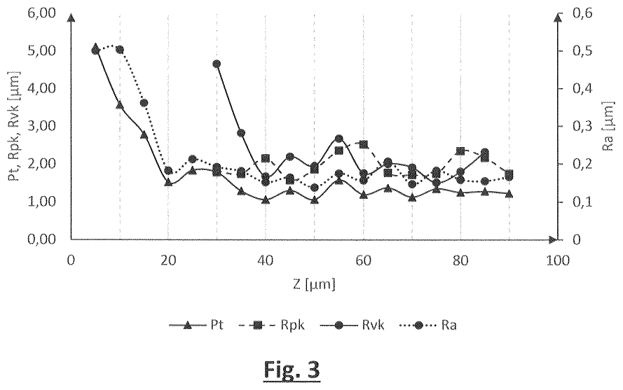

This is illustrated in FIG. 2.

FIG. 2a shows at first a tooth flank that has only been ground and is under-polished respectively, with only minimal smoothing of the tips.

FIG. 2b shows the case where the peaks are smoothed, resulting in a high carrying fraction (flatter Abbott curve). However, there are still residual valleys in the profile, which are the result of the previous grinding process. Normally, the aim is to achieve an Abbott curve like this.

FIG. 2c shows a completely polished surface, which can be described as over-polished in terms of the design of the surface of a gear tooth flank. Only minimal residual valleys remain here, which also reduces the oil retention capacity. The Abbott curve is even flatter here than in FIG. 2b.

The Rvk value of the Abbott curve (see FIG. 1) is ultimately relevant for the retention capacity of lubricants.

The resulting transition from an only ground surface of a tooth flank to a polished surface is shown in FIG. 3. The figure shows the progression of roughness parameters (in particular Ra, Rpk, and Rvk according to the Abbott curve, see FIG. 1) that result from a relative radial infeed Z of the polish grinding tool to the gear being polished.

It can be seen that a certain infeed Z is required before any noticeable influence on the surface roughness can be detected. Reference is made, for example, to the Ra value, which cannot be influenced at all with infeeds below 10 μm. This is ultimately due to the elasticity of the polish grinding tool. Its abrasive particles are usually fixed to the tool base in an elastic bond (e.g., polyurethane), so that a certain minimum infeed is required before any influence can be detected.

The proposed procedure involves the following steps:

First, a reference gear or test gear is mounted on the workpiece spindle of a (polishing) grinding machine. The reference gear is finished ground; only the polish grinding process remains. The reference gear can be the first workpiece in a batch to be produced, which may then be polish grinded to a good part; however, it can also be a gear that will become a scrap part after the described machining and measurement process.

A polish grinding tool is clamped onto the tool spindle, which may in particular be a polish grinding worm whose bond consists of plastic (in particular polyurethane) and which (in comparison with a grinding worm for finishing the toothing) is correspondingly flexible or elastic.

The reference gear or test gear is now used as follows:

A (preferably single) reference tooth gap is defined on the reference gear, which forms the basis for further examination. The tooth gap is measured using a tactile measuring element (measuring probe). A specified grid of measuring points is approached both above the tooth height (i.e., in the radial direction of the gear) and above the tooth width (i.e., in the axial direction of the gear), and the position of the surface of the two opposing tooth flanks of the reference tooth gap is recorded and stored (see step a 1 above). For example, 10 measuring points can be provided above the tooth height and 5 measuring points above the tooth width, resulting in 50 measuring points per tooth flank in this case.

The gear is now polish grinded for the first time using the polish grinding tool. The tool is fed to the gear with an initial radial (small) infeed (see step a2 above).

The surface of the tooth flanks is then measured again; the position of the surface (in the example, at the 10×5=50 measuring points) is recorded and stored again (see step a 3 above).

The measuring points are now compared as they are before and after the first polish grinding process (see step a4 above). The first initial radial infeed is selected so that no change is expected at all measuring points as a result of the first polish grinding process. For example, the first radial infeed can be in the range of 10 μm, with which the tool immerges relative to the workpiece, based on the target geometry of the tooth flanks.

In this respect, the aforementioned comparison (according to step a4) will regularly show that the position of the surface of the opposing tooth flanks at the measuring points does not completely correspond to the measured position according to step a1 at all measuring points; changes will regularly only have occurred at some measuring points.

For all measuring points for which a change from the initial position has already been detected, the size of the radial infeed that led to the change in the surface and the measuring point in question are recorded or stored. This radial infeed leads, via the geometric conditions on the flank surface (i.e., due to the shape of the involute), to a corresponding infeed normal to the flank surface, to which the desired immersion depth ( ) for polish grinding is then added in order to achieve the desired target penetration (see FIG. 5).

Since changes have not yet occurred at all measuring points, polish grinding is now continued (in accordance with step a5″) in such a way that the polish grinding tool is now advanced by an incremental amount of the radial infeed. This incremental amount can be between 20 μm and 40 μm, for example, and in particular 30 μm. After renewed polish grinding, the measurement is repeated and checked to see whether changes have now occurred at all measuring points compared to the initial state.

Measuring points for which a change from the initial state is now detected are recorded again and the last radial infeed used for this purpose and the resulting penetration respectively (see FIG. 5) is stored.

The process is repeated with further incremental increases in the infeed until the measurement shows that the measured values at all measuring points have changed compared to the initial state.

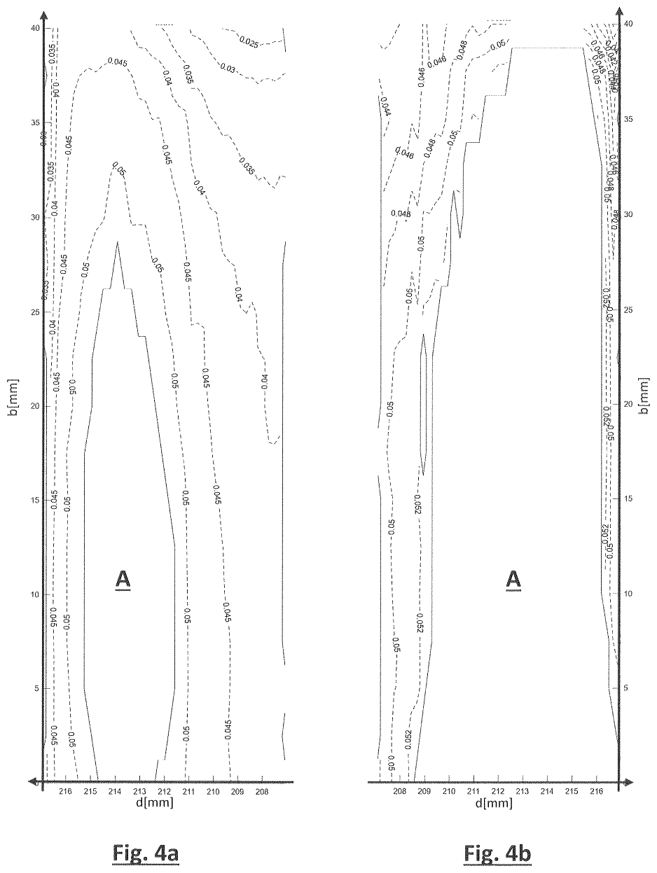

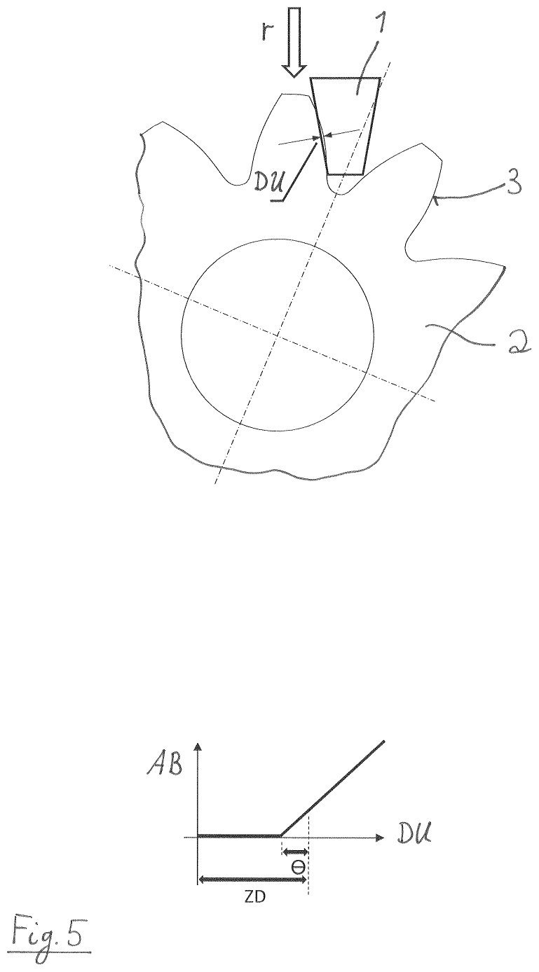

FIGS. 4a and 4b show the measured progression and the surface position of the tooth flank respectively (in FIG. 4a for the left tooth flank and in FIG. 4b for the right tooth flank of the reference tooth gap) for one of these intermediate states (between the first polish grinding and the last polish grinding). The entered (iso)lines (“0.04,” “0.045,” “0.05,” etc. in mm) indicate the removal over the area of the tooth flank (see AB in FIG. 5).

In both FIGS. 4a and 4b, an area marked “A” is shown where there has been no change compared to the first measurement. Accordingly, polish grinding is continued with a further increase in increment until, after a final repetition, a change has occurred at all measurement points on the tooth flanks.

If this is the case, the polish grinding process is terminated and the data obtained is used as the basis for determining a correction value or correction function (see step b above).

According to an initial preferred embodiment, the idea is to use the data obtained as a basis for subsequently polish grinding the gears in such a way that the symmetry of the two opposing tooth flanks, relative to the center of the tooth gap, is improved.

For this purpose, differences are calculated for both the left and right tooth flanks of the reference tooth gap machined as described above at the measuring points (in the example, at the 10×5=50 measuring points), which result from the respective infeed until the change in geometry minus the infeed at the start of the process. An average value (e.g., the arithmetic mean: sum of all differences for all measuring points divided by the number of measuring points) can be determined for these differences, so that a value is available for both the left and right tooth flanks of the reference tooth gap. Now, based on this, a rotation angle of the workpiece relative to the tool (i.e., a rotation around the C-axis) can be calculated, for example, in relation to the pitch circle of the toothing, so that the tool is placed symmetrically relative to the workpiece and to the tooth gaps to be ground respectively.

In the mentioned embodiment, the correction value (according to step b) above) consists thus of a specific angle of rotation around the workpiece axis, which is taken into account during the subsequent polish grinding (according to step c above) in order to machine the gear wheels with improved symmetry of the tooth gaps in relation to their center plane.

FIG. 5 illustrates how, due to the geometric conditions (i.e., specifically due to the angle between the surface normal at a given point on the flank surface 3 and the radial direction r) a radial infeed r of the polish grinding tool 1 to the workpiece 2 (gear) results in an infeed and thus a penetration DU perpendicular to the surface of the tooth flank 3 (see upper image in FIG. 5). Accordingly, the upper image in FIG. 5 shows how a radial infeed r leads to a penetration DU that is to be understood as perpendicular to the flank surface 3; there is thus a correlation between the radial infeed r and the penetration DU that results from the geometric conditions of the toothing.

The lower image in FIG. 5 shows, in the form of a coordinate system, which penetration DU results in which removal AB on the tooth flank 3.

With reference to the explanations in FIG. 3, it should be noted that a certain amount of infeed (normal to the tooth flank) is required in order to achieve any effect at all. As explained above (see step a above), a certain penetration DU must first be achieved for the individual points on the surface of the tooth flanks before any change in the surface can be detected (see lower image in FIG. 5: initially, there is no removal AB with increasing penetration DU, which is why the curve runs along the abscissa). Only when sufficient penetration DU is achieved does the change in the surface begin at the relevant point on the tooth flank (see rising straight line from the start of ). At this point, the immersion depth (e.g., 5 μm, 10 μm, 15 μm, or 20 μm) is then added (see lower image in FIG. 5) with which the polish grinding process as such is to be carried out in order to achieve the desired target penetration ZD. According to the described procedure, this is done for the entire surface of the tooth flanks, i.e., according to the measuring points provided there in the radial direction and in the width direction of the toothing.

The target penetration ZD is therefore obtained when, after performing step a) above, the desired defined immersion depth is added to the individual points in order to achieve the desired polishing effect.

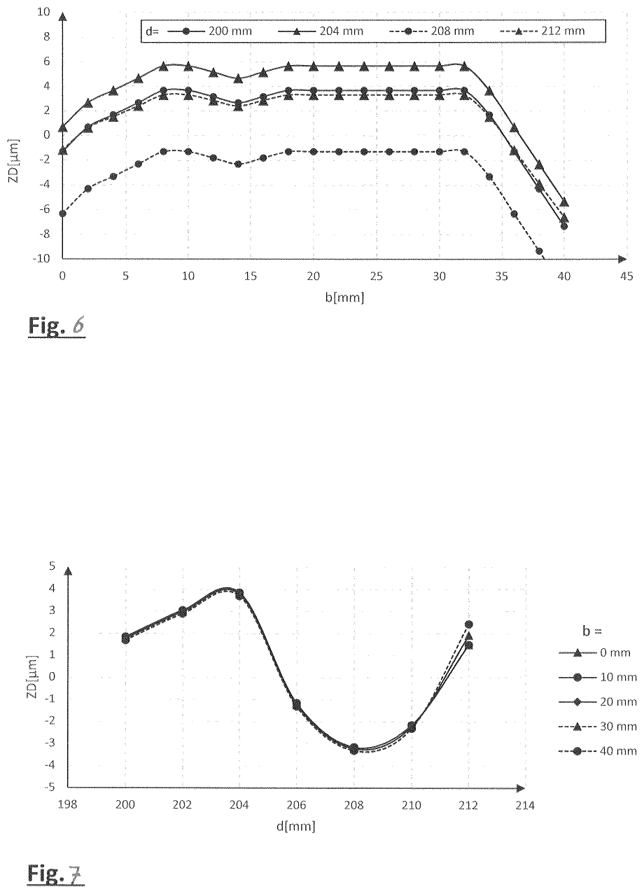

The data set determined above for the individual measuring points (relating to the aforementioned difference) can also be used, according to a further embodiment of the invention, to improve the tooth line in the direction of the axis of rotation of the gear, i.e., in the width direction of the toothing, during polish grinding (according to step c) above. This procedure is illustrated in FIG. 6.

This figure shows how the target penetration ZD (in μm) varies across the tooth width b for different diameters d (i.e., across the tooth height). Reference is made to FIG. 5 for the definition of the target penetration ZD.

As can be seen in FIG. 6, the various diameters d ultimately result in a similar curve across the tooth width b. For all recorded curves, a mean value (e.g., an arithmetic mean) can again be determined, so that a single representative curve is formed from the total of seven curves shown in FIG. 6, which applies to the target penetration ZD over the width b of the toothing.

This curve can then be taken into account as a correction function during the polish grinding of gears (according to step c above), i.e., a line correction of the toothing is taken into account by means of a variable radial infeed (X-axis) along the axis direction of the toothing (Z-axis) in the machine control system. The representative curve obtained from FIG. 6 is thus “countered”, so to speak, during polish grinding and machining along the workpiece axis in order to achieve an improved line as a result.

The mentioned line correction can also be performed in particular via a Z-dependent infeed (of the X-axis) in combination with a Z-dependent rotation around the workpiece axis (C-axis) during the subsequent polish grinding (according to step c above). It is also possible to apply the correction by deliberately shifting the tool along its axis of rotation (shift axis: Y-axis) during polish grinding.

Another possible embodiment of the method consists of determining a correction function that is based on the tooth profile (i.e., the profile over the height of the toothing). This is illustrated in FIG. 7.

Here, the target penetration ZD (in μm) is shown above the diameter d of the gear (i.e., above the toothing height) for all measured points along the tooth width (the curves are all very similar and therefore close together). From this data, a mean value (e.g., the arithmetic mean) can be calculated to define a function that is used to modify the toothing during the subsequent polish grinding process (according to step c above).

However, in this case, the correction function is taken into account during the subsequent polish grinding (according to step c above) in such a way that the function obtained from FIG. 7 is taken into account when dressing the polish grinding tool (i.e., in particular the grinding screw).

The dressing process is therefore carried out in such a way that the function resulting from FIG. 7 is “counteracted” or superimposed when dressing the polishing part of the tool.

Accordingly, the toothing profile can be specifically influenced.

It should be mentioned at this point that the determined correction functions can also be implemented using conventional methods, for example by defining a spline function that describes the desired corrections and is taken into account when controlling the axes. Similarly, a polynomial can also be defined for the correction function, which is then taken into account by the machine control system.

The following can therefore be concluded:

When the described method for determining local polishing conditions is applied, a compensation topology (correction value or correction function) is available for the subsequent polish grinding (according to step c above).

The procedural approach allows local polishing properties on the surface of the tooth flanks to be taken into account, thereby defining a compensating topology that balances out the local differences in penetration.

The described method makes it possible to transfer the measured values to the kinematics of the machine during polish grinding or to take them into account when dressing the grinding worm using a correction value or correction function.

This makes it easy and cost-effective to achieve improved results in polish grinding. The flank surface can be produced to a higher quality. The process can be automated, making it inexpensive to implement.

The above describes three specific solutions that improve the symmetry of the tooth gap, the tooth line, and the tooth profile. These approaches can be implemented individually or in any combination.

To improve symmetry, the flanks are compensated by determining a compensation rotation angle for the workpiece, as described above. The averaged target penetration on both measured flanks of the reference tooth gap is thus compensated by a C-axis correction.

Similarly, a compensation function can be used to influence the surface geometry of the tooth flanks in the line direction (i.e., in the direction of the gear's axis of rotation). Here, several axes of the machine are interpolated by the control system in order to implement the determined compensation function during polish grinding.

However, a compensating function affecting the profile (above the tooth height) can be taken into account when dressing the grinding tool.

While specific embodiments of the invention have been shown and described in detail to illustrate the inventive principles, it will be understood that the invention may be embodied otherwise without departing from such principles.

We claim:

1. Method for polish grinding of gears with a polish grinding tool in a gear grinding machine, comprising the steps of:
a) Performing the following steps on a reference gear or test gear:
a1) Measuring at least one tooth gap of the finish ground, but not yet polish ground gear, wherein the position of the surface of the flanks is measured at a number of points on the flanks (measuring points) on both opposing flanks of the tooth gap, both above the tooth height and above the tooth width;
a2) Polish grinding the gear with the polish grinding tool, wherein the polish grinding tool is fed to the gear with a first initial radial infeed;
a3) Measuring the surface of the flanks to determine the position of the surface at the number of points on the flanks;
a4) Comparing the measured position of the surface at the number of points on the flanks according to step a3) with the measured position of the surface at the number of points on the flanks according to step a1);
a5′) If the comparison according to step a4) shows that the position of the surface at the number of points on the flanks according to step a3) has changed relative to the measured position of the surface at the number of points on the flanks according to step a1) at all measured points on the flanks: Continue with step b);
a5″) If the comparison according to step a4) shows that the position of the surface at the number of points on the flanks according to step a3) has not yet changed with respect to the measured position of the surface at the number of points on the flanks according to step a1) at least at one of the measured points on the flanks:
Storing of the measured points on the flanks where a change has already occurred, as well as the necessary radial infeed for that,
Repeating steps a2), a3), and a4), wherein with each repetition the polish grinding tool is fed to the gear wheel with a radial infeed increased by one increment, wherein continuation with step b) takes place if, after a repetition, a change has occurred at all measured points on the flanks;
b) Determination of at least one correction value and/or at least one correction function for the subsequent polish grinding from the determined radial infeeds that were required for a change at all measured points on the flanks;
c) Polish grinding of gears based on the determined correction value and/or the determined correction function.

2. The method according to claim 1, wherein the measuring according to step a1) is performed at exactly one reference tooth gap.

3. The method according to claim 1, wherein between 3 and 20 measuring points are arranged equidistantly over the tooth height.

4. The method according to claim 3, wherein between 3 and 10 measuring points are arranged equidistantly across the tooth width.

5. The method according to claim 1, wherein the determination of a correction value according to step b) relates to the symmetry between the two tooth flanks of the tooth gap of the toothing to be polish grinded.

6. The method according to claim 5, wherein an average value is formed for both the right flank and the left flank from the stored radial infeeds at the measured points on the flanks according to step a5″), at which a change has occurred for the first time, wherein a compensating angle of rotation is determined from the difference between the average values of the left and right flanks, by which the gear is rotated during machining by a machine axis in order to symmetrically polish grinding the opposite flanks of the tooth gap.

7. The method according to claim 1, wherein the determination of a correction function according to step b) relates to the flank line of the toothing to be polish grinded.

8. The method according to claim 7, wherein, from the stored radial infeeds at the measured points on the flanks according to step a5″), at which a change has occurred for the first time, an average course of the flank line over the width of the toothing is determined, wherein the course of the flank line thus determined is taken into account as a correction during polish grinding in order to obtain a desired course of the flank line.

9. The method according to claim 1, wherein the determination of a correction function according to step b) relates to the flank profile of the toothing to be polish grinded.

10. The method according to claim 9, wherein, from the stored radial infeeds at the measured points on the flanks according to step a5″), at which a change has occurred for the first time, an average profile of the flank over the height of the toothing is determined, wherein the profile of the flank thus determined is taken into account as a correction when dressing the polish grinding tool in order to obtain a desired profile of the flank during polish grinding.

11. The method according to claim 1, wherein the measuring according to step a1) and according to step a3) is performed in the workpiece clamping in the gear grinding machine.

12. The method according to claim 1, wherein the measuring according to step a1) and according to step a3) is performed by means of a tactile measuring element, in particular with a measuring probe.

13. The method according to claim 1, wherein the polish grinding tool is a grinding worm.

14. The method according to claim 13, wherein the grinding worm has abrasive grains which are held in place by an elastic bond, in particular a plastic bond, preferably a polyurethane bond.

15. The method according to claim 1, wherein the increment for the radial infeed is between 10 μm and 50 μm, preferably between 20 μm and 40 μm, and particularly preferably 30 μm.
